(19) United States
(12) Patent Application Publication
(10) Pub. No.: US 2025/0047081 A1
(43) Pub. Date: Feb. 6, 2025

(54) SOLAR WIRE STRIPPER WITH NON-ALIGNED STRIPPING HOLES

(71) Applicant: Klein Tools, Inc., Lincolnshire, IL (US)

(72) Inventor: Grant Storm, Mansfield, TX (US)

(73) Assignee: Klein Tools, Inc., Lincolnshire, IL (US)

(21) Appl. No.: 18/779,542

(22) Filed: Jul. 22, 2024

Related U.S. Application Data
(60) Provisional application No. 63/529,975, filed on Jul. 31, 2023.

(51) Int. Cl. H02G 1/12

(52) U.S. Cl. CPC H02G 1/1212

(57) ABSTRACT

A hand tool for stripping wire includes a first handle and a second handle. The hand tool includes a first base member having a first jaw section and a second base member having a second jaw section. The hand tool includes a clamping portion corresponding to the first jaw section, the clamping portion having a bottom clamping member defining a clamping plane and a top clamping member. The hand tool includes a stripping blade set, including a fixed blade disposed on a first side of the second jaw and a movable blade disposed on a second side of the second jaw. The fixed blade and the movable blade form a first stripping hole, a second stripping hole, and a third stripping hole, the first stripping hole, second stripping hole, and the third stripping hole each having different offset from the clamping plane.

### CROSS-REFERENCE TO RELATED APPLICATIONS

This patent application claims priority of U.S. Provisional Patent Application No. 63/529,975 filed on Jul. 31, 2023, the entire contents of which is herein incorporated by reference.

### BACKGROUND OF THE DISCLOSURE

The present wire strippers, and more specifically, to wire strippers with non-aligned stripping holes. Wire strippers are used to remove insulation from electrical wires. Wire strippers may be designed to remove the insulation of wires of varying sizes, eliminating the need for using multiple wire strippers or manual adjustment of wire strippers. Many conventional wire strippers are known, including the hand tool of U.S. Pat. No. 8,863,620, filed on Jul. 19, 2012, entitled “HAND TOOL WITH STRIPPING AND SHEARING FUNCTIONS,” which his hereby incorporated by reference in its entirety. It is desirable to provide a wire stripper that can cleanly remove the insulation from an electrical wire without damaging the core wire.

### BRIEF SUMMARY OF THE DISCLOSURE

In accordance with one feature of this disclosure, a hand tool for stripping wire is provided and includes a first handle and a second handle. The hand tool includes a first base member having a first jaw section and a second base member having a second jaw section, the first base member and the second base member being pivotally coupled to the first handle and the second handle. The hand tool includes a clamping portion corresponding to the first jaw section, the clamping portion having a bottom clamping member defining a clamping plane and a top clamping member. The hand tool includes a stripping blade set, including a fixed blade disposed on a first side of the second jaw and a movable blade disposed on a second side of the second jaw. The fixed blade and the movable blade form a first stripping hole, a second stripping hole, and a third stripping hole, the first stripping hole, second stripping hole, and the third stripping hole each having different offset from the clamping plane.

In one feature, the hand tool includes a first link rod pivotally coupled to the first handle and the clamping portion and a second link rod pivotally coupled to the second handle and the movable blade.

According to another feature, the first handle and second handle are symmetrical and pivotally coupled to each other.

As one feature, each of the first stripping hole, second stripping hole, and third stripping hole are offset from each other.

In one feature, a midpoint of the second stripping hole is offset, perpendicular to the clamping plane by 0.015 inches above the first stripping hole and the midpoint of the third stripping hole is offset perpendicular to the clamping plane by 0.015 inches above the second stripping hole.

According to one feature, the first stripping hole has a radius of 0.052 inches, the second stripping hole has a radius of 0.069 inches, and the third stripping hole has a radius of 0.069 inches.

As one feature, the stripping blade set further forms a fourth stripping hole having a midpoint having a same offset from the clamping plane as at one of the first stripping hole, second stripping hole, or third stripping hole.

In one feature, the second stripping hole has a larger radius than the first stripping hole.

In accordance with one feature, a hand tool for stripping wire includes a first handle and a second handle. The hand tool includes a first base member having a first jaw section and a second base member having a second jaw section, the first base member and the second base member being pivotally coupled to the first handle and the second handle. The hand tool includes a clamping portion corresponding to the first jaw section and defining a clamping plane. The hand tool includes a stripping blade set, including a fixed blade disposed on a first side of the second jaw and a movable blade disposed on a second side of the second jaw. The fixed blade and the movable blade form at least two stripping holes, the at least two stripping holes each having a midpoint offset from the clamping plane by a different distance than each other.

In one feature, the hand tool further includes a first link rod pivotally coupled to the first handle and the clamping portion and a second link rod pivotally coupled to the second handle and the movable blade.

According to another feature, the first handle and second handle are symmetrical and pivotally coupled to each other.

As one feature, each of the at least two stripping holes are offset from each other.

According to one feature the stripping blade set further forms a third stripping hole having an offset from the clamping plane by a same distance as at one at one of the at least two stripping holes.

As another feature, the stripping blade set further forms a third stripping hole having an offset from the clamping plane by a different distance than the at least two stripping holes.

In accordance with one feature, a hand tool for stripping wire includes a first handle and a second handle. The hand tool includes a first base member having a first jaw section and a second base member having a second jaw section, the first base member and the second base member being pivotally coupled to the first handle and the second handle. The hand tool includes a clamping portion corresponding to the first jaw section. The hand tool includes a stripping blade set, including a fixed blade disposed on a first side of the second jaw and a movable blade disposed on a second side of the second jaw. The fixed blade and the movable blade form a first stripping hole, a second stripping hole, and a third stripping hole, the first stripping hole, second stripping hole, and the third stripping hole each having a midpoint offset from each other.

In one feature, the hand tool further includes a first link rod pivotally coupled to the first handle and the clamping portion and a second link rod pivotally coupled to the second handle and the movable blade.

According to another feature, the first handle and second handle are symmetrical and pivotally coupled to each other.

As one feature, a midpoint of the second stripping hole is offset by 0.015 inches above the first stripping hole and the midpoint of the third stripping hole is offset by 0.015 inches above the second stripping hole.

According to one feature, the first stripping hole has a radius of 0.052 inches, the second stripping hole has a radius of 0.069 inches, and the third stripping hole has a radius of 0.069 inches.

As another feature, the stripping blade set further forms a fourth stripping hole having a midpoint that is not offset from the first stripping hole, second stripping hole, or third stripping hole.

### BRIEF DESCRIPTION OF THE DRAWINGS

FIG. 1 is a perspective view of a wire stripper.

FIG. 2 is a front view of the wire stripper of FIG. 1.

FIG. 3 is a side view of the wire stripper of FIG. 1.

FIG. 4 is another side view of the wire stripper of FIG. 1.

FIG. 5 is a view showing a blade set having non-aligned stripping holes for use with the wire stripper of FIG. 1.

FIG. 6A is a front view of a portion of a conventional automatic stripper with aligned stripping holes shown stripping the insulation from a wire.

FIG. 6B is another view of the conventional automatic stripper with aligned stripping holes shown stripping the insulation from a wire.

FIG. 7 shows the blade set of FIG. 5 with dimensions and relative alignment of the stripping holes.

### DETAILED DESCRIPTION OF PREFERRED EMBODIMENTS

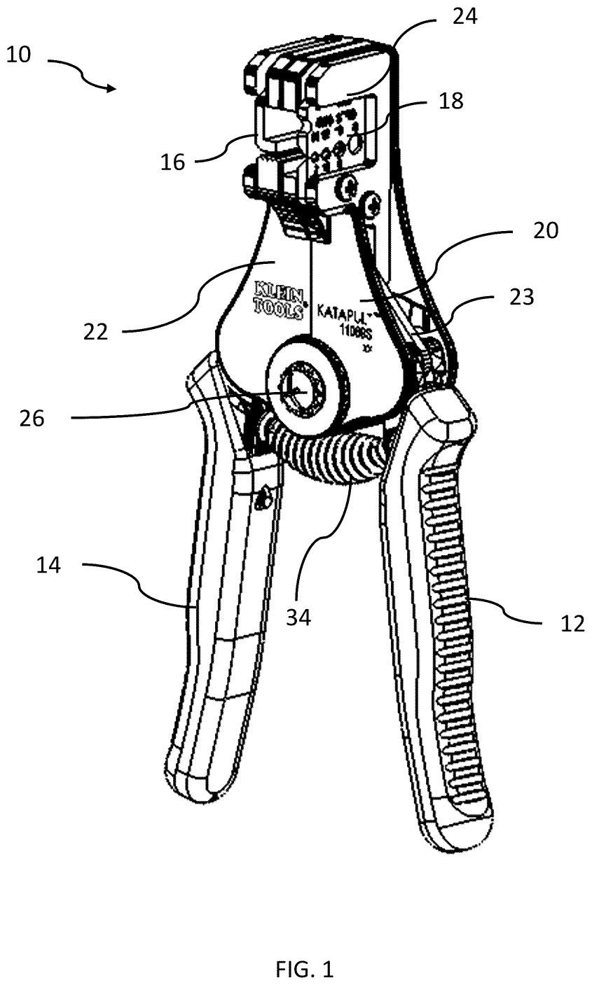

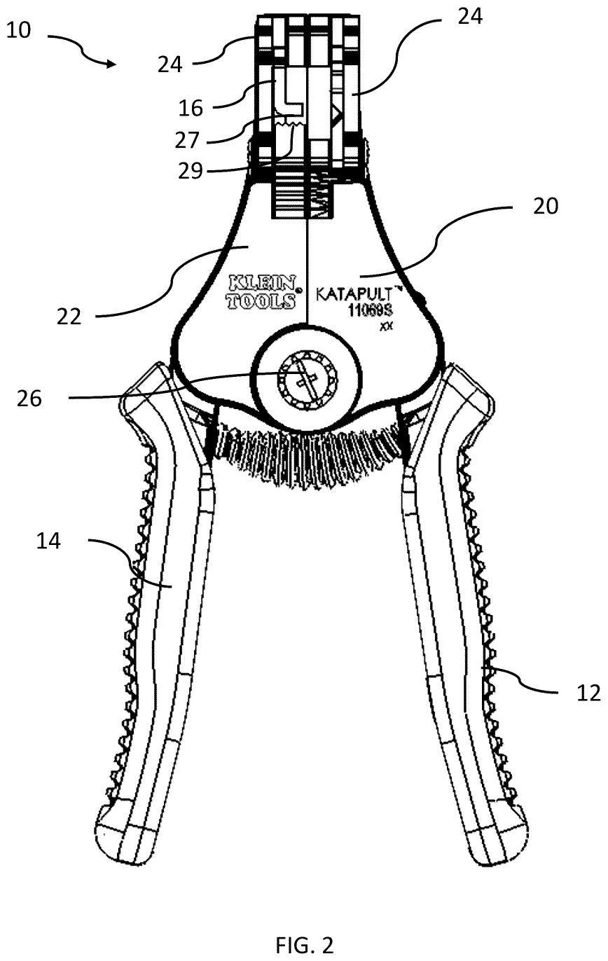

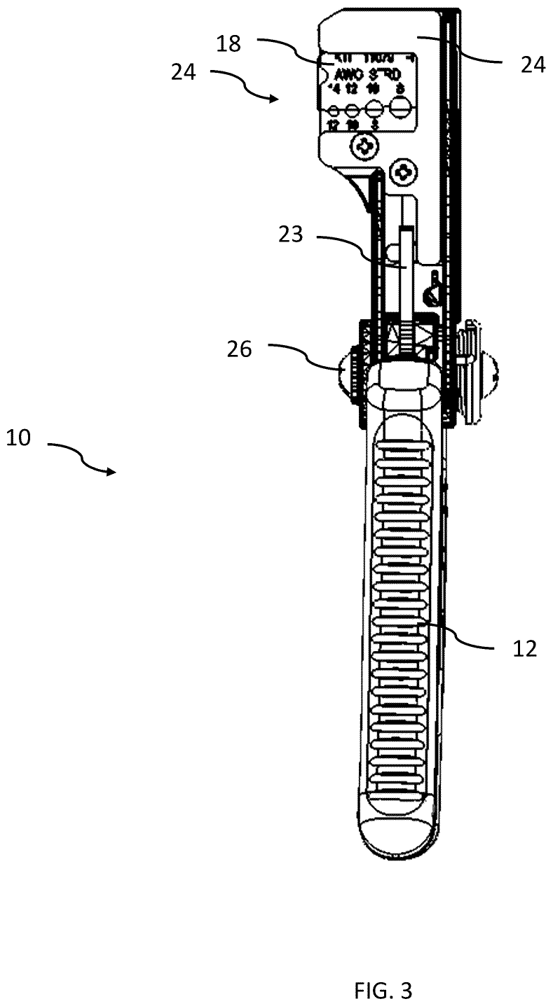

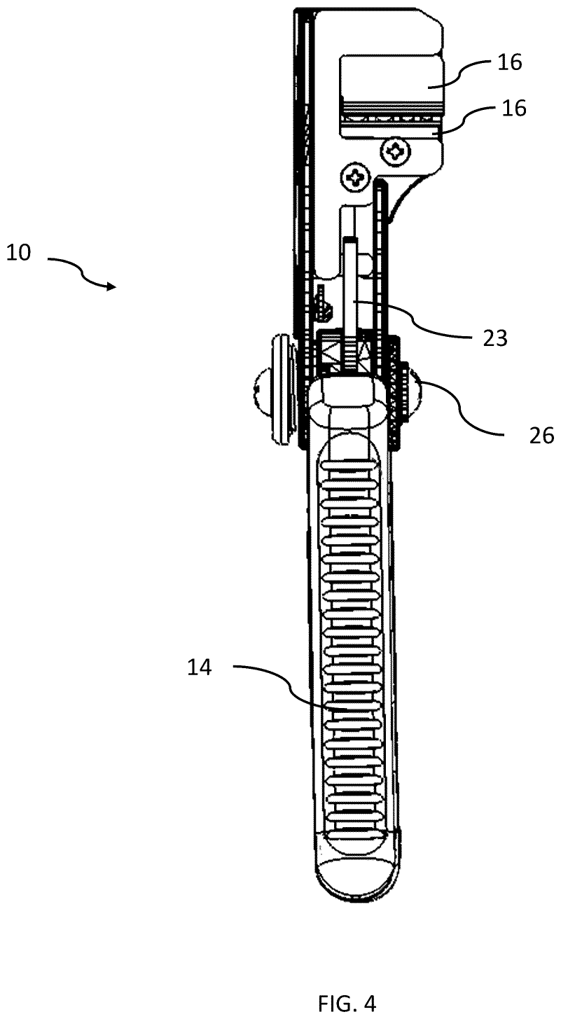

As best seen in FIGS. 1-4, a wire stripper 10 hand tool is provided for removing (e.g., stripping) insulation from a wire (e.g., electrical wire). In the illustrated and preferred embodiment, the wire stripper 10 includes a pair of handles (e.g., first handle 12 and second handle 14), a clamping portion 16, a stripping blade set 18, and a pair of base members (e.g., first base member 20 and second base member 22). The first handle 12 and the second handle 14 are connected to the clamping portion 16 and stripping blade set 18 via a link rod set such that the wire stripper 10 strips the insulation from a wire when the first handle 12 and second handle 14 are actuated.

In the illustrated and preferred embodiment, first base member 20 and the second base member 22 are substantially symmetrical members each having a jaw section 24. The first base member 20 and the second base member 22 are pivotally coupled to the first handle 12 and the second handle 14 at a pivot 26.

In the illustrated and preferred embodiment, the clamping portion 16 is positioned within the jaw section 24 of the second base member 22. In the illustrated and preferred embodiment, jaw section 24 of the second base member 22 includes a ridged (e.g., serrated, patterned, grooved) surface 27. The clamping portion 16 has a clamping surface 29 opposite the ridged surface of the jaw section 24 of the second base member 22 to grip an exterior portion of a wire. The clamping portion 16 is movable relative to the ridged surface of the jaw section 24. In the illustrated and preferred embodiment, the clamping surface 29 of the clamping portion defines a clamping plane.

In the illustrated and preferred embodiment, the stripping blade set 18 includes a fixed blade 28 and a movable blade 30. In the illustrated and preferred embodiment, the jaw section 24 of the first base member 20 includes the stripping blade set 18.

In the illustrated and preferred embodiment, the link rod set includes a pair of link rods 23. One link rod 23 is pivotally coupled to the first handle 12 and the movable blade 30 of the stripping blade set 18. The other link rod 23 is pivotally coupled to the second handle 14 and the clamping portion 16. When the first handle 12 and the second handle 14 are actuated towards each other (e.g., squeezed together by a user), the first handle actuates the movable blade 30 (e.g., driven towards the fixed blade 28) and the second handle 14 actuates the clamping portion 16 (e.g., driven towards the ridged surface 27 of the jaw section 24 of the second base member 22).

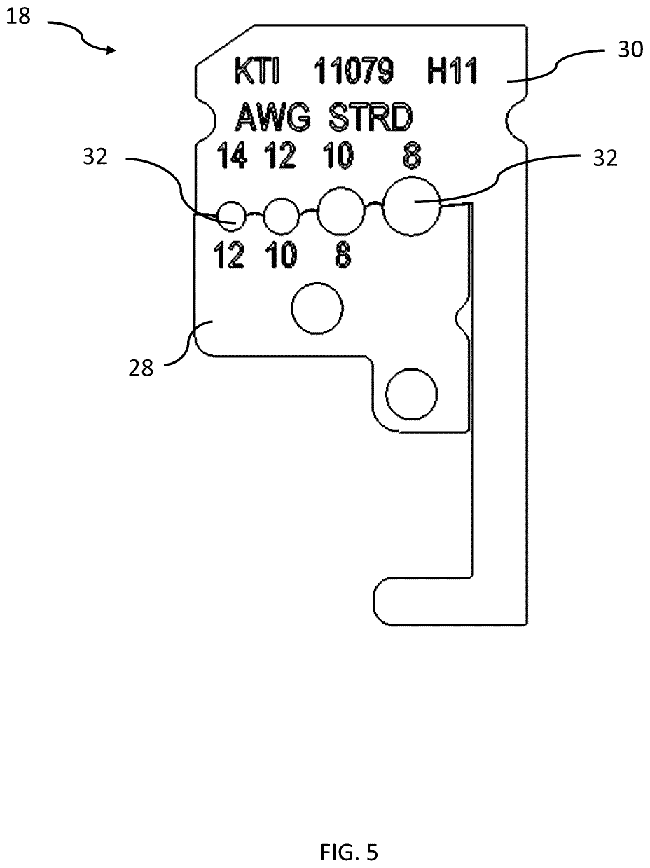

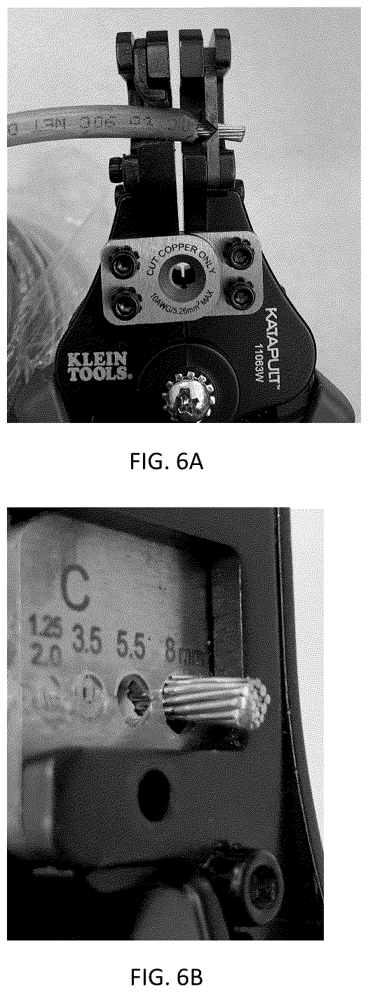

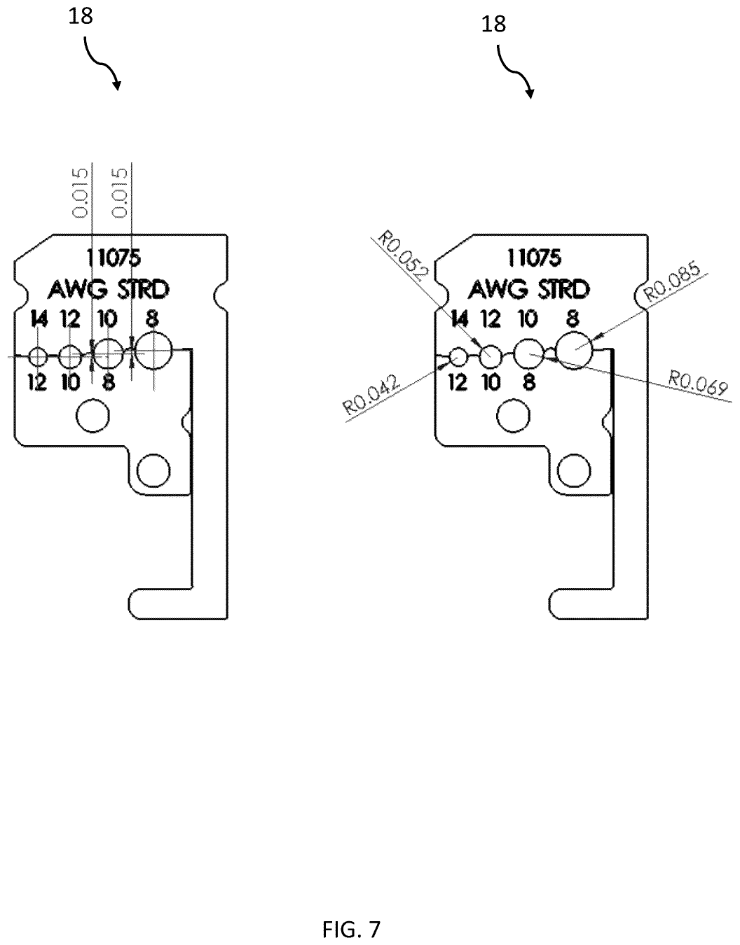

As best shown in FIG. 5, the stripping blade set 18 includes non-aligned stripping holes 32 (e.g., gaps) for cutting the insulation (e.g., insulation layer) of a wire without cutting the wire's core (e.g., core wire). In the illustrated and preferred embodiment, the stripping blade set 18 includes four stripping holes 32. In the illustrated and preferred embodiment, each stripping hole 32 is sized to strip wire having a different gauge (e.g., AWG). For example, each stripping hole 32 may have a different circumference and/or diameter. In the illustrated and preferred embodiment, the stripping holes 32 are sized to strip wiring having 12 AWG solid (e.g., 14 AWG stranded), 10 AWG solid (e.g., 12 AWG stranded), 8 AWG solid (e.g., 10 AWG stranded), or 8 AWG stranded. Conventional strippers known in the art use aligned stripping holes. However, as best shown in FIGS. 6A and 6B, conventional aligned strippers may nick the wire core while stripping the wire. For example, by gripping and centering the wire in a position that is higher than the alignment of the corresponding stripping holes (e.g., as seen in FIG. 6B). In the illustrated and preferred embodiment, one or more of the stripping holes 32 are not aligned with one or more of the other stripping holes 32. In the illustrated and preferred embodiment, the 14 AWG stranded and 12 AWG stranded stripping holes 32 are aligned with each other. The center of the 14 AWG stranded and 12 AWG stranded stripping holes 32 (e.g., formed by the fixed blade 28 and the movable blade 30 are aligned with each other. In the illustrated and preferred example, the center of the 10 AWG stranded stripping hole 32 is 0.015 inches above the 14 AWG stranded and 12 AWG stranded stripping holes 32. In the illustrated and preferred example, the center of the 8 AWG stranded stripping hole 32 is 0.015 inches above the 10 AWG stranded stripping hole. In the illustrated and preferred embodiment, the stripping holes 32 for use with lower gauge wire (e.g., wire having larger diameters) are raised relative to the stripping holes 32 for use with higher gauge wire. In the illustrated and preferred embodiment, the center of the stripping holes 32 are aligned with the middle of the point at which the clamping portion 16 grips the wire as the handles 12, 14 of the wire stripper 10 are squeezed together.

In the illustrated and preferred embodiment, three of the four stripping holes 32 are offset from each other. In the illustrated and preferred embodiment, the offset stripping holes 32 have a midpoint (e.g., center) that is offset from the midpoint of at least one other stripping hole 32. In the illustrated and preferred embodiment, the midpoints of the stripping holes 32 having midpoints offset from the clamping plane by varying (e.g., different) distances.

In the illustrated and preferred embodiment, the first base member 20 and the second base member 22 pivot away from each other when the first handle 12 and the second handle 14 are actuated (e.g., squeezed together by a user). This pivoting moves the jaw section 24 of the first base member 20 and the jaw section 24 of the second base member 22 away from each other. In the illustrated and preferred embodiment, the wire stripper 10 includes a spring 34 coupled to the first handle 12 and the second handle 14 to bias the handles apart.

In the illustrated and preferred embodiment, an electrical wire may be stripped by the wire stripper 10 by placing the wire into the jaw sections 24 of the first base member 20 and the second base member 22. The first handle 12 and the second handle 14 may be actuated (e.g., squeezed together), driving the clamping portion 16 (e.g., via the rod members 23) to engage the insulation of the wire between the ridged surface 27 and clamping surface 29 of the jaw section 24 of the second base member 22 to clamp the wire in place. The actuation of the first handle 12 and the second handle 14 drive the fixed blade 28 and the movable blade 30 blade together. The fixed blade 28 and movable blade 30 pierce (e.g., cut) the insulation around the insulated wire. Continued actuation of the first handle 12 and the second handle 14 pivots the jaw sections 24 of the first base member 20 and second base member 22 away from each other, causing the blade set 18 to remove the cut insulation from the insulated wire which is retained by the clamping portion 16.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the wire stripper 10 are shown in the figures, it should be understood that this disclosure anticipates variations in the specific details of each of the disclosed components and features of the material dispenser and that no limitation to a specific form, configuration, or detail is intended unless expressly and specifically recited in an appended claim.

For example, while specific and preferred forms have been shown for the alignment of the striping holes 32, other alignments may be used. In some examples three stripping holes 32 may be aligned and one stripping hole 32 may not be aligned. In some examples, all four stripping holes 32 may not be aligned.

While the offset of the non-aligned stripping holes 32 is shown as 0.015 inches in the illustrated and preferred embodiment, other offsets may be used. For example, when the stripping holes may be offset by less than 0.015 inches (e.g., 0.01 inches).

In some examples, the offset may be more than 0.015 inches (e.g., 0.02, 0.025, 0.03 inches). In some examples, the offset may be greater than 0.03 inches.

In some examples, the stripping blade set 18 may include three stripping holes 32 with one or more of the stripping holes 32 being non-aligned. In some examples, the stripping blade set 18 may include 5 or more stripping holes, with varying combinations of aligned and non-aligned stripping holes 32.

In some examples, the location of the stripping holes 32 on the striping blade set 18 is based on the alignment of the striping blade set 18 with position where the clamping portion 16 grips the insulated wire. In some examples, the alignment differential between two stripping holes 32 may correspond to the diameter difference between the stripping holes 32. The offset of the stripping holes may be approximately half of the difference between the diameters of the stripping holes 32. In an example where a first stripping hole 32 diameter is 0.042 inches and a second stripping holes 32 diameter is 0.069 inches, the diameter difference is 0.027 inches, and the offset between the two stripping holes is 0.0135 inches (e.g., about 0.015 inches).

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

What is claimed is:

1. A hand tool for stripping wire, comprising:
a first handle and a second handle;
a first base member having a first jaw section and a second base member having a second jaw section, the first base member and the second base member being pivotally coupled to the first handle and the second handle;
a clamping portion corresponding to the first jaw section, the clamping portion having a bottom clamping member defining a clamping plane and a top clamping member; and
a stripping blade set, including a fixed blade disposed on a first side of the second jaw and a movable blade disposed on a second side of the second jaw;
wherein the fixed blade and the movable blade form a first stripping hole, a second stripping hole, and a third stripping hole, the first stripping hole, second stripping hole, and the third stripping hole each having different offset from the clamping plane.

2. The hand tool of claim 1, further comprising a first link rod pivotally coupled to the first handle and the clamping portion and a second link rod pivotally coupled to the second handle and the movable blade.

3. The hand tool of claim 1, wherein the first handle and second handle are symmetrical and pivotally coupled to each other.

4. The hand tool of claim 1, wherein each of the first stripping hole, second stripping hole, and third stripping hole are offset from each other.

5. The hand tool of claim 4, wherein a midpoint of the second stripping hole is offset, perpendicular to the clamping plane by 0.015 inches above the first stripping hole and the midpoint of the third stripping hole is offset perpendicular to the clamping plane by 0.015 inches above the second stripping hole.

6. The hand tool of claim 1, wherein the first stripping hole has a radius of 0.052 inches, the second stripping hole has a radius of 0.069 inches, and the third stripping hole has a radius of 0.069 inches.

7. The hand tool of claim 1, wherein the stripping blade set further forms a fourth stripping hole having a midpoint having a same offset from the clamping plane as at one of the first stripping hole, second stripping hole, or third stripping hole.

8. The hand tool of claim 1, wherein the second stripping hole has a larger radius than the first stripping hole.

9. A hand tool for stripping wire, comprising:
a first handle and a second handle;
a first base member having a first jaw section and a second base member having a second jaw section, the first base member and the second base member being pivotally coupled to the first handle and the second handle;
a clamping portion corresponding to the first jaw section and defining a clamping plane; and
a stripping blade set, including a fixed blade disposed on a first side of the second jaw and a movable blade disposed on a second side of the second jaw;
wherein the fixed blade and the movable blade form at least two stripping holes, the at least two stripping holes each having a midpoint offset from the clamping plane by a different distance than each other.

10. The hand tool of claim 9, further comprising a first link rod pivotally coupled to the first handle and the clamping portion and a second link rod pivotally coupled to the second handle and the movable blade.

11. The hand tool of claim 9, wherein the first handle and second handle are symmetrical and pivotally coupled to each other.

12. The hand tool of claim 9, wherein each of the at least two stripping holes are offset from each other.

13. The hand tool of claim 9, wherein the stripping blade set further forms a third stripping hole having an offset from the clamping plane by a same distance as at one at one of the at least two stripping holes.

14. The hand tool of claim 9, wherein the stripping blade set further forms a third stripping hole having an offset from the clamping plane by a different distance than the at least two stripping holes.

15. A hand tool for stripping wire, comprising:
a first handle and a second handle;
a first base member having a first jaw section and a second base member having a second jaw section, the first base member and the second base member being pivotally coupled to the first handle and the second handle;
a clamping portion corresponding to the first jaw section and; and
a stripping blade set, including a fixed blade disposed on a first side of the second jaw and a movable blade disposed on a second side of the second jaw;
wherein the fixed blade and the movable blade form a first stripping hole, a second stripping hole, and a third stripping hole, the first stripping hole, second stripping hole, and the third stripping hole each having a midpoint offset from each other.

16. The hand tool of claim 1, further comprising a first link rod pivotally coupled to the first handle and the clamping portion and a second link rod pivotally coupled to the second handle and the movable blade.

17. The hand tool of claim 15, wherein the first handle and second handle are symmetrical and pivotally coupled to each other.

18. The hand tool of claim 15, wherein a midpoint of the second stripping hole is offset by 0.015 inches above the first stripping hole and the midpoint of the third stripping hole is offset by 0.015 inches above the second stripping hole.

19. The hand tool of claim 15, wherein the first stripping hole has a radius of 0.052 inches, the second stripping hole has a radius of 0.069 inches, and the third stripping hole has a radius of 0.069 inches.

20. The hand tool of claim 15, wherein the stripping blade set further forms a fourth stripping hole having a midpoint that is not offset from the first stripping hole, second stripping hole, or third stripping hole.
